(19) United States
(12) Patent Application Publication
(10) Pub. No.: US 2016/0127716 A1
(43) Pub. Date: May 5, 2016

(54) VIRTUAL REALITY UNDERWATER MASK

(71) Applicant: JUAN CARLOS RAMIRO, FRESNEDOSO DE IBOR (ES)

(72) Inventor: JUAN CARLOS RAMIRO, FRESNEDOSO DE IBOR (ES)

(21) Appl. No.: 14/526,554

(22) Filed: Oct. 29, 2014

(51) Int. Cl. H04N 13/04; G06F 3/16; G06F 3/0482; B63C 11/20; G06F 3/0488; H04N 5/225; B63C 11/16; G06T 19/00; G06F 3/14

(52) U.S. Cl. CPC H04N 13/044; G06T 19/006; G06F 3/16; G06F 3/0482; G06F 3/14; G06F 3/0488; H04N 5/2252; B63C 11/16; B63C 11/205; H04N 2201/02483; G06F 2203/04808; B63C 2011/121

(57) ABSTRACT

The proposed invention refers to an underwater virtual reality mask which makes it possible to breathe easily and naturally under water while observing the virtual reality on a screen such as a smartphone screen, and which has all the intrinsic control elements such as lenses, a speaker, a button to control the screen functions and a device for breathing while the wearer is semi-submerged.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION TECHNICAL FIELD

The technical field of the invention refers to that of virtual reality devices, and more specifically to virtual reality devices for use under water, so that the industrial sector would be that of manufacturers of virtual reality devices and manufacturers of underwater masks.

### DESCRIPTION OF THE RELATED ART

A virtual reality device is normally used out of water, in a room, lounge or outdoor space.

The following related prior art may be cited:

U.S. Pat. No. D701,206 S1 for a “VIRTUAL REALITY HEADSET”.

The most significant difference from this invention is that the device in the US patent cannot be used under water.

U.S. Pat. No. D338,514 S for a “HELMET FOR PROVIDING VIRTUAL REALITY ENVIRONMENTS”.

The main difference from this invention is that the device in the US patent cannot be used under water.

Neither of the antecedents mentioned includes the item which is the subject of this patent, namely an underwater virtual reality mask making it possible to breathe easily and naturally under water while observing the virtual reality on a screen, such as a smartphone screen.

The inventor is unaware of any patent previously incorporating the elements of this invention nor the advantages generated by those elements.

### BRIEF SUMMARY OF THE INVENTION

The invention proposed refers to a virtual reality underwater mask making it possible to breathe easily and naturally under water while observing the virtual reality on a screen, such as a smartphone screen.

The fundamental elements mentioned for the device's operation include a plastic housing forming the mask itself, an adaptable silicone elastic seal preventing the entry of water and allowing the wearer to submerge, two biconvex lenses and an adjustment device using a worm screw connected to an external wheel, and a screen, such as a smartphone screen.

The device has a special system which uses incoming air necessary for breathing to cool the Smartphone or an electronic screen.

The upper part of the air input has a valve which prevents the entry of water if submerged, using a system which prevents the entry of air if the device is submerged in water.

It also has an internal valve allowing air to enter when the wearer breathes, and which closes when breathing out.

A valve in the lower part facilitates the expulsion of water which enters the mask, while preventing it from entering from outside when submerged.

An attachment tape facilitates the correct adjustment between the silicone seal and the wearer's head.

The underwater mask also incorporates a special camera to display the wearer's hands, to interact with the virtual reality appearing on the screen, along with a speaker and a device to handle and control the virtual screen menus.

### BRIEF DESCRIPTION OF THE DRAWINGS

Five pages of plans are included for a better understanding of the invention, showing the following:

FIG. 1. A diagrammatic representation of a user wearing an underwater virtual reality mask, in the water.

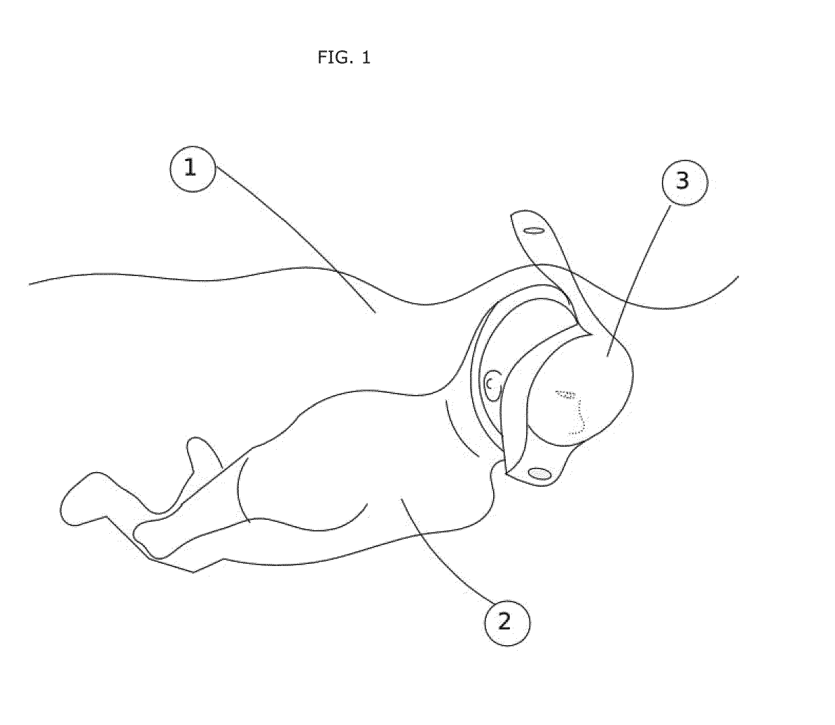

FIG. 2. The diagrammatic arrangement of the main elements of the invention.

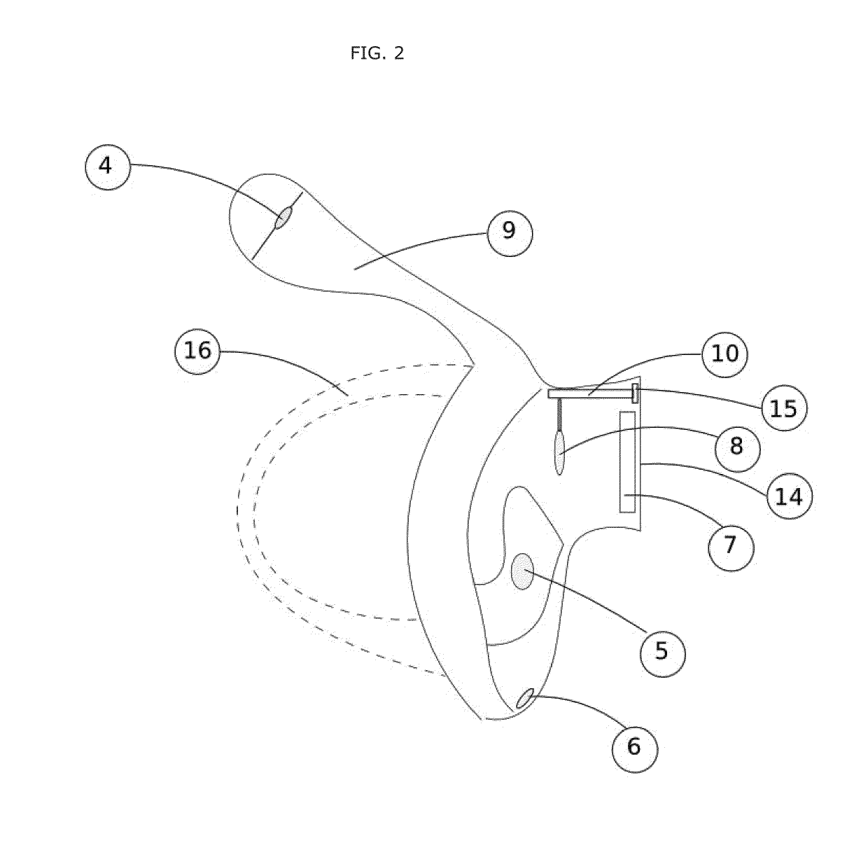

FIG. 3. The diagrammatic arrangement of the main external components of the underwater virtual reality mask.

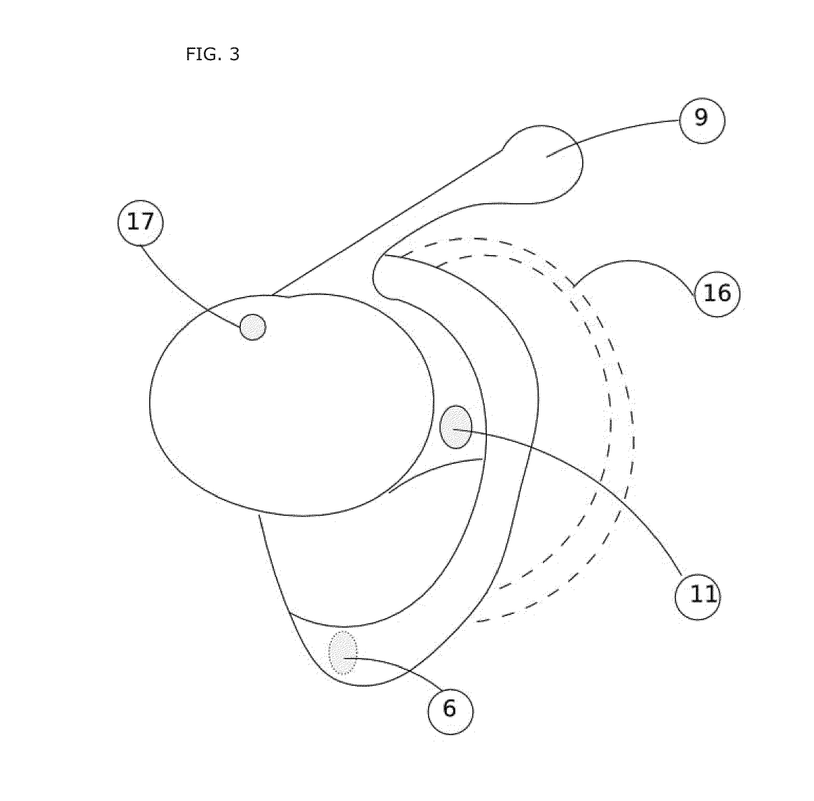

FIG. 4. The diagrammatic arrangement of the main internal components of the underwater virtual reality mask.

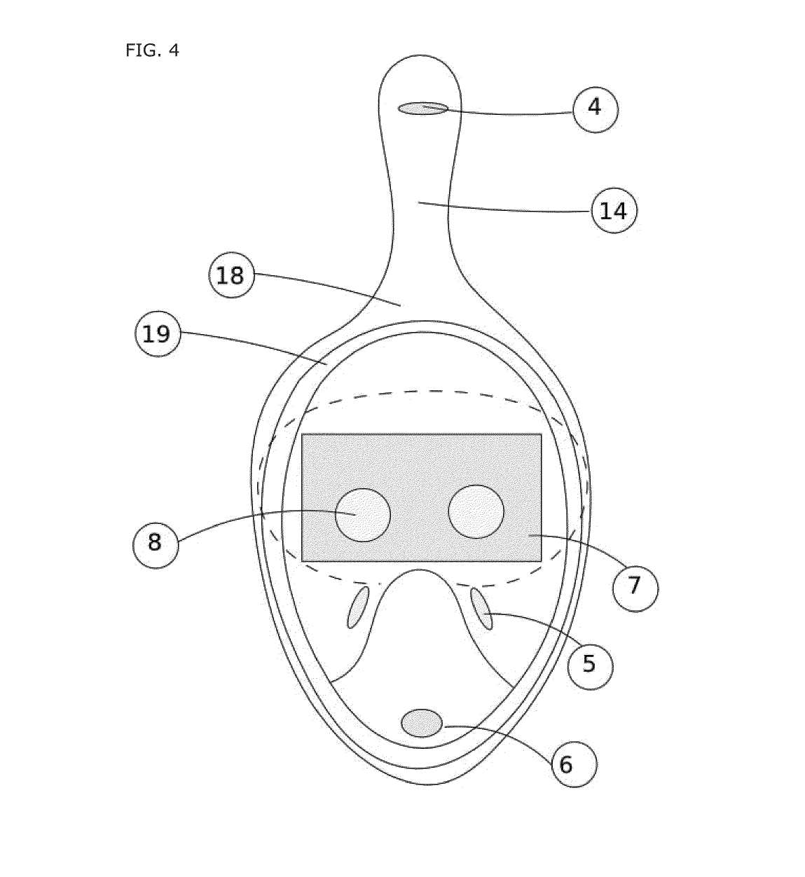

FIG. 5. The diagrammatic layout of the air cooling of the underwater virtual reality mask's screen.

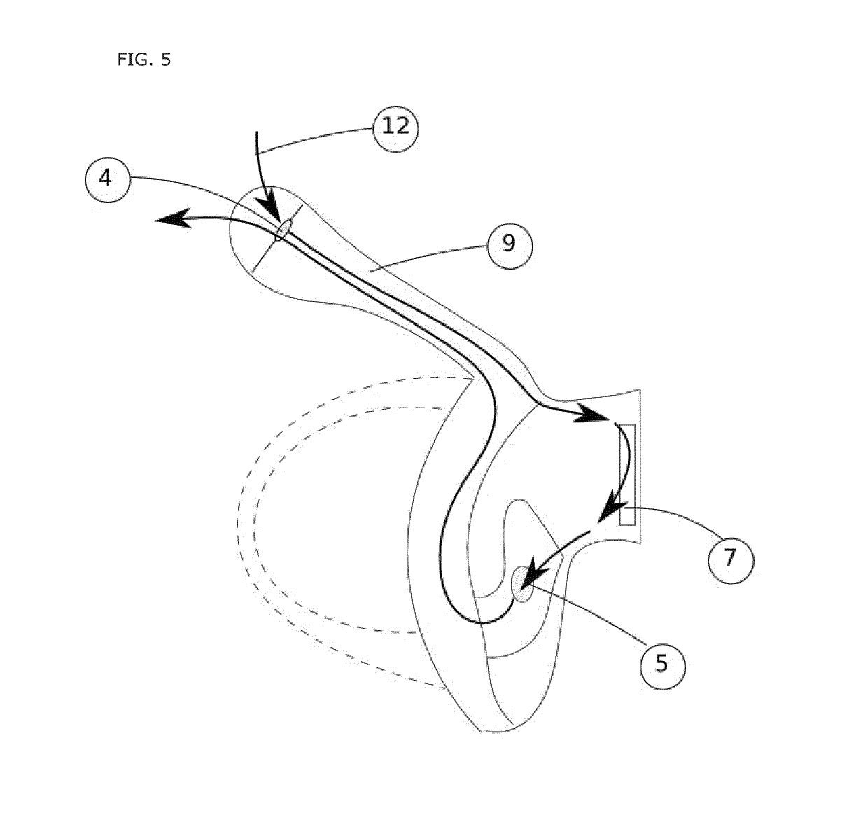

In all, the following elements are made out:

(1).—water

(2).—user

(3).—underwater virtual reality mask

(4).—external air input/output stop valve

(5).—internal air input valve

(6).—internal water output valve

(7).—smartphone

(8).—lens

(9).—air input circuit

(10).—lens adjustment worm screw

(11).—operating pinion

(12).—air input valve

(13).—cooling air output

(14).—closing cover

(15).—screw adjustment external wheel

(16).—tape to secure the underwater mask

(17).—menu control button

(18).—plastic housing

(19).—silicone adjustment seal

(20).—touchpad

(21).—special camera to display the hands

(29).—air output circuit

(22).—underwater speaker

### DETAILED DESCRIPTION OF THE INVENTION

### Description of the Preferred Embodiment

The proposed invention refers to an underwater virtual reality mask (3) which makes it possible to breathe easily and naturally under water while observing the virtual reality on a screen such as a smart phone screen (7).

The device and its parts comprise essentially the following elements:

a plastic housing (18) forming the mask itself, with

an adaptable elastic silicone seal (19) preventing the entry of water, and allowing the user to submerge,

two lenses (8) located in front of the electronic screen (7),

and a smartphone (7).

An underwater mask air input valve (12) making use of the input of air needed to breathe cool the smartphone (7).

An external valve (4) on the upper part of the air input, preventing water input when submerged, by interrupting the air input by valve (12) if the device is submerged completely in water (1).

An internal valve (5) allowing air input when breathing in and which is closed when breathing out.

An internal valve (6) in the lower part of the underwater mask facilitating discharge of water entering mask and at the same time preventing it from entering from outside when completely submerged.

A securing tape (16) which facilitates the correct adjustment between the silicone seal (19) and the wearer's head (2).

A worm screw (10) to adjust the lens (8), making it possible to move the lens in or out using a pinion (11) joined to the external shifting wheel (15).

A mobile closing cover (14) allows access to the smartphone (7) and prevents the entry of water when submerged.

The air input and output duct makes it possible to breathe while partially submerged in the water using an input (9) duct and an output duct (29) and also has an external air input/output valve (4) which is out of the water when partially submerged.

An underwater speaker (22) is integrated, making it possible to hear the sound of the images being seen on the smartphone screen (7).

A menu control button (17) to access the main smartphone screen menu (7).

A touchpad (20) to access and navigate in the smartphone screen menu (7).

A special camera (21) to visualise the wearer's hands, to interact with the virtual reality appearing on the smartphone screen (7).

Having sufficiently described the nature of this invention and how to put it into practice, it must be recorded that the above specifications, represented in the attached drawings, may be modified in detail in so far as that does not alter their fundamental principles set out in the previous paragraphs and summarised in the following claims.

1. AN UNDERWATER VIRTUAL REALITY MASK making it possible to breath easily and naturally under water while observing the virtual reality on an electronic screen, characterised by comprising essentially the following elements:
A plastic housing (18) forming the mask as such, with
an adaptable elastic silicone seal (19) preventing entry of water and able to be submerged,
two lenses (8) located in front of the smartphone electronic screen (7),
and a smartphone (7).
An underwater mask air input, valve (12) which uses the input of air necessary to breathe, to cool the smartphone (7).
An exterior valve (4) on the upper part of the air input preventing water from entering when submerged, by interrupting the input of air by valve (12) if the device is submerged completely in water (1).
An interior valve (5) allowing air input on breathing in and which is closed on breathing out.
An interior valve (6) on the lower part of the underwater mask, facilitating discharge of water which enters the mask, while preventing it from entering from the outside when completely submerged.
An attachment tape (16) facilitating the correct adjustment between the silicone seal (19) and the wearer's head (2).
A worm screw (10) to adjust the biconvex lenses (8), making it possible to move the lens in or out using a pinion (11) joined to the external shifting wheel (15).
A mobile closing cover (14) allows access to the smartphone (7) and prevents the of water when submerged.
The air input and output duct makes it possible to breathe while partially submerged in the water using an input duct and an output duct (29), and also has an external air input/output valve (4) which is out of the water when partially submerged.
An underwater speaker (22) is integrated, making it possible to hear the sound of the images seen on the smartphone screen (7).
A menu control button (17) to access the main smartphone screen menu (7).
A touchpad (20) to access and navigate the smartphone screen menu (7).
A special camera (21) to visualise the wearer's hands, to interact with the virtual reality appearing on the smartphone screen (7).

2. AN UNDERWATER VIRTUAL REALITY MASK making it possible to breathe easily and naturally under water while observing the virtual reality on a screen such as a smartphone screen (7), as set forth in claim 1 and characterised because the smartphone (7) can be replaced by an electronic screen.

3. AN UNDERWATER VIRTUAL REALITY MASK making it possible to breathe easily and naturally under water while observing the virtual reality on an electronic screen, as set forth in claims 1 and 2 and characterised because the menu control button (17) allows the smartphone (7) or electronic screen menu to be opened.

4. AN UNDERWATER VIRTUAL REALITY MASK making it possible to breathe easily and naturally under water while observing the virtual reality on an electronic screen, as set forth in previous claims and characterised because the menu control button (17) may also have other functions to assign, in addition to deploying the menu.

5. AN UNDERWATER VIRTUAL REALITY MASK making it possible to breathe easily and naturally under water while observing the virtual reality on an electronic screen, as set forth in previous claims and characterised because the touchpad (20) makes it possible to browse the main menu in addition to other functions to handle the screen of the smartphone (7) or the electronic screen.

6. AN UNDERWATER VIRTUAL REALITY MASK making it possible to breathe easily and naturally under water while observing the virtual reality on an electronic screen, as set forth in previous claims and characterised because the lens (8) can be biconvex, spherical, semi-spherical or similar.
